(19) United States
(12) Patent Application Publication
(10) Pub. No.: US 2012/0066153 A1
(43) Pub. Date: Mar. 15, 2012

(54) SHIPPING LABEL KIOSK

(75) Inventor: Harry T. Whitehouse, Portola Valley, CA (US)

(73) Assignee: PSI SYSTEMS, INC., Palo Alto, CA (US)

(21) Appl. No.: 13/212,010

(22) Filed: Aug. 17, 2011

Related U.S. Application Data
(60) Provisional application No. 61/374,804, filed on Aug. 18, 2010.

(51) Int. Cl. G06Q 10/08

(52) U.S. Cl. 705/407; 705/408; 358/1.1

(57) ABSTRACT

A method and system for generating a mailing label includes inputting data relating to an item to be mailed into a first computer system; printing, by the first computer system, an information-bearing mark onto a base material, the information-bearing mark associated with the data relating to the item; reading, by a second computer system, the information-bearing mark on the base material; and printing, by the second computer system, the mailing label for mailing the item based on the read information-bearing mark.

### CROSS-REFERENCE TO RELATED APPLICATIONS

This application claims the benefit of priority from U.S. Provisional Patent Application No. 61/374,804, filed Aug. 18, 2010, the content of which is incorporated herein by reference in its entirety.

### FIELD OF THE INVENTION

The present invention pertains to shipping and mailing and in particular to a method and system for generating a mailing label for mailing an item.

### DISCUSSION OF RELATED ART

Self-service kiosks are already being used by the United States Postal Service (USPS) as a convenient way for mailing and shipping packages, letters or parcels without the assistance of a clerk or a sales associate. The self-service kiosk has equipment that allows a customer to buy stamps or mail letters and packages in a self-service environment where the customer performs the operations of inputting data (e.g., destination zip code, etc.) and weighing the package, etc. without any assistance from a postal clerk. The self-service kiosk or equipment is often located in a post office lobby. Customers can purchase stamps or mail letters, packages and parcels using debit or credit cards.

A USPS self-service kiosk is equivalent to a bank automated teller machine (ATM). In this respect, the USPS self-service kiosk is also often referred to as Automated Postal Center (APC). APCs provide a quick, easy and convenient way for customers to weigh, calculate and apply exact postage, and ship Express Mail and Priority Mail items, packages and First-Class letters. APCs also provide easy access to other postal products and services the same way ATMs provide access to banking products and services.

APCs dispense information based indicia (IBI) postage in any First-Class Mail, Priority Mail®, Parcel Post®, and Express Mail® denomination. APCs also dispense First-Class postage stamps, print the Click-N-Ship™-style electronic label and Return Receipt, and provide Postal Service and mailing information, including ZIP Code lookup. The APCs provide a touch-screen customer interface, an integrated scale for weighing and rating mailing items, and a debit/credit card swipe and pin pad.

However, USPS self-service kiosks or APCs are provided within the confines of a post office. Therefore, there is a need for a method a system for generating a label for mailing an item in a self-service environment by using a self-service kiosk that can be provided outside the confines of a post office, for example in a hotel, retail business, or the like.

### BRIEF SUMMARY OF THE INVENTION

An aspect of the present invention is to provide a method for generating a mailing label. The method includes inputting data relating to an item to be mailed into a first computer system; printing, by the first computer system, an information-bearing mark onto a base material, the information-bearing mark associated with the data relating to the item; reading, by a second computer system, the information-bearing mark on the base material; and printing, by the second computer system, the mailing label for mailing the item based on the read information-bearing mark.

Another aspect of the present invention is to provide a system for generating a mailing label including a first computer system configured to print an information-bearing mark on a base material, the information-bearing mark associated with data relating to the item; and a second computer system configured to read the information-bearing mark on the base material, and print the mailing label for mailing the item based on the read information-bearing mark.

Although the various steps of the method of providing or printing postage stamps are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a schematic diagram of a system for generating the mailing label, according to an embodiment of the present invention;

FIG. 2 is a flow chart of a method of generating a mailing label, according to an embodiment of the invention;

FIGS. 3A-3I show various graphical user interfaces of a first application for inputting shipping data, according to an embodiment of the present invention;

FIG. 4 depicts an example of a printed base material (e.g., a paper slip) output by a printing device, according to an embodiment of the present invention;

FIG. 5 depicts the graphical user interface 40, according to an embodiment of the present invention; and

FIG. 6 is an example of a shipping label, according to an embodiment of the present invention.

### DETAILED DESCRIPTION OF EMBODIMENTS OF THE INVENTION

FIG. 1 is a schematic diagram of a system for generating the mailing label, according to an embodiment of the present invention. The system 10 includes a first computer system 12 and a second computer system 14. The first computer system 12 includes an input device 121, a display device 122, a printing device or printer 123, and a processor 124. The input device 121, the display device 122, and the printer 123 are in communication with processor 124. The input device 121 can be of any type, such as a keyboard, a mouse, a trackball, a joystick, or a touch-screen type input device, or any combination thereof. The display device 122 can be of any type, for example, a LCD screen, a projection screen, or a head-mounted-display (HMD) device, or any combination thereof. For example, in the case where the input device 121 is a touch screen, the input device 121 and the display device 122 can be integrated as a same device that plays the role of input device 121 and display device 122. The printing device 123 can be any type of printer. For example, in one embodiment, the printer 123 is DYMO printer, from ENDICIA. In another embodiment, the printer 123 can be an ink-jet or laser printer, just for example. The printer 123 is used to output data in a printed form.

In one embodiment, the input device 121 and the display device 122 are provided in a public environment in a form of a kiosk 125 so as to be publicly accessible. The processor or processing unit (CPU) 124 can be localized within the kiosk 125 or provided remote from the kiosk 125.

In one embodiment, the first computer system 12 may further include a weighing scale 126 for weighing the package to measure its weight for proper mail rate evaluation. In one embodiment, the weighing scale 126 is located within the kiosk 125. The weighing scale 126 is accessible to the user so as to allow the user to weigh the package to be shipped. The printer 123 or a an output of the printer 123 is also accessible to the user so as to allow the user to collect a printed base material (e.g., printed paper slip).

The second computer 14 includes an input device 141, a display device 142, a printing device or printer 143 and a processor 144. The input device 141, the display device 142 and the printer 143 are in communication with the processor 144. The input device 141 includes a scanning or image reading device such as, but not limited to, a barcode reader. The display device 142 can be of any type, for example, a LCD device, a projection screen or HIVID device or any combination thereof. The printer 143 can be any type of printer. In one embodiment, the printer 143 is a DYMO printer, from ENDICIA.

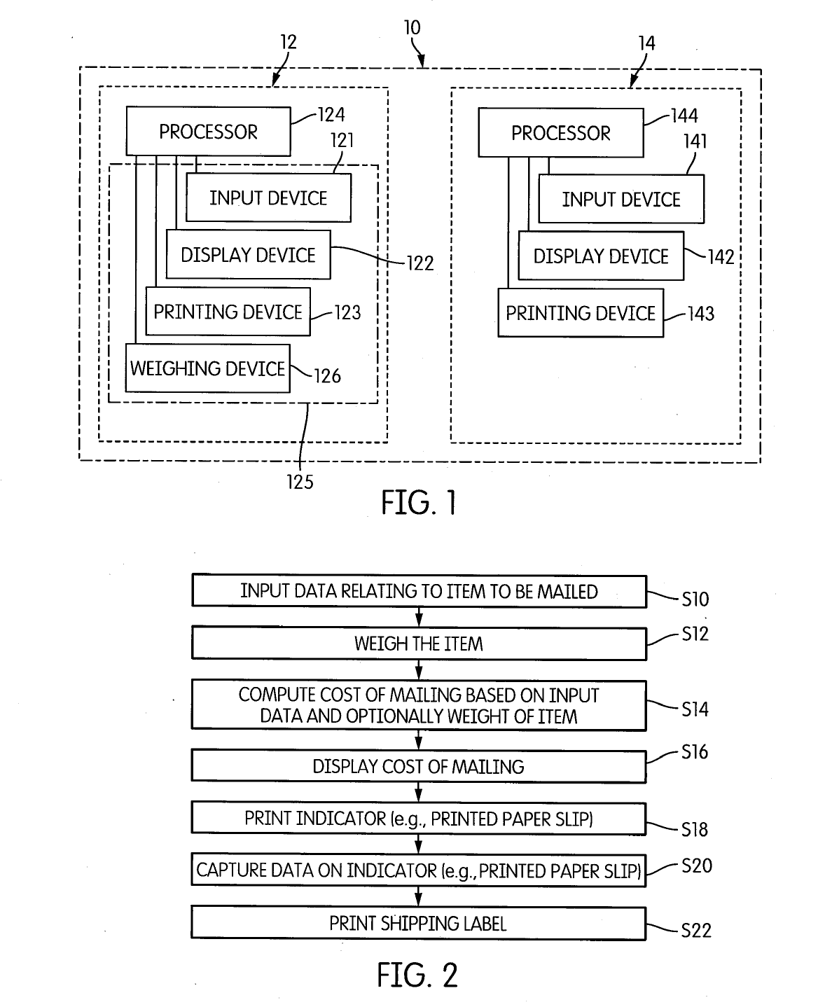

FIG. 2 is a flow chart of a method of generating a mailing label, according to an embodiment of the invention. The method includes inputting data by a user on a series of graphical user interfaces 20A-201 displayed on the display device 122 of the first computer system 12, at S10. The graphical user interfaces 20A-20I are displayed on the display device 122 by first software application running on first computer system 12. The inputting includes inputting by a user or customer a destination address, a destination zip code. In one embodiment, the inputting further includes inputting a type of mailing service to be used for mailing the item (e.g., Priority Mail, Express Mail, etc.), dimensions of item (e.g., dimensions of the package to be mailed), or any combination thereof. In one embodiment, the inputting includes inputting the data using the input device 121 and displaying the input data in graphical user interfaces 20A-20I on display device 122.

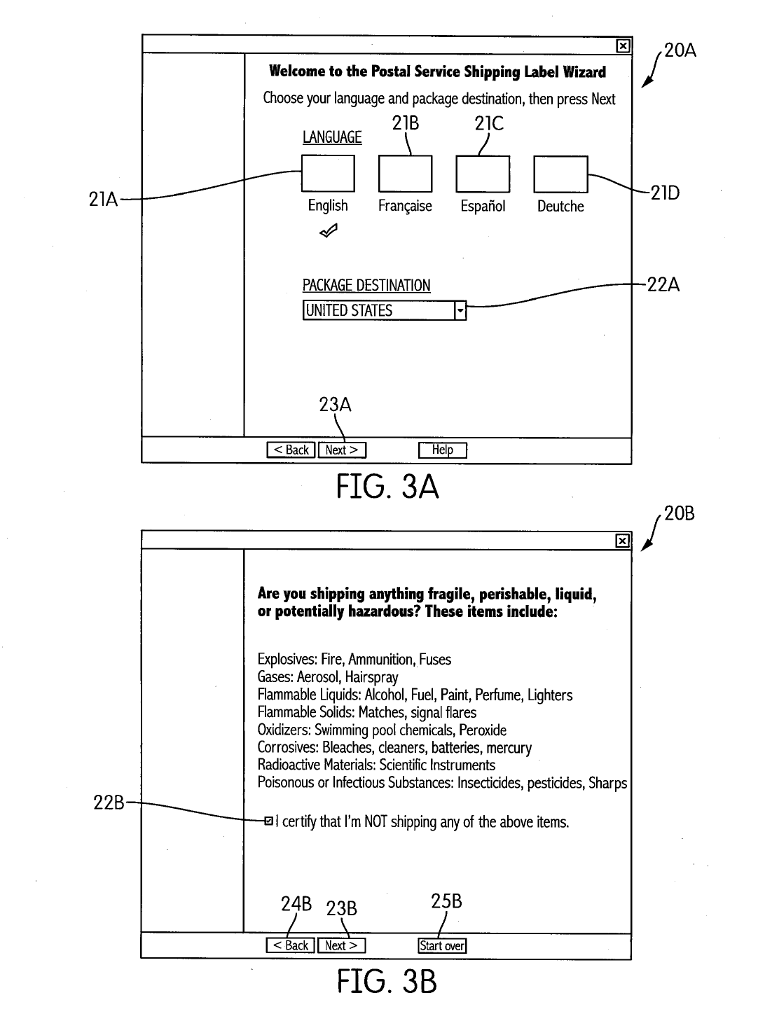

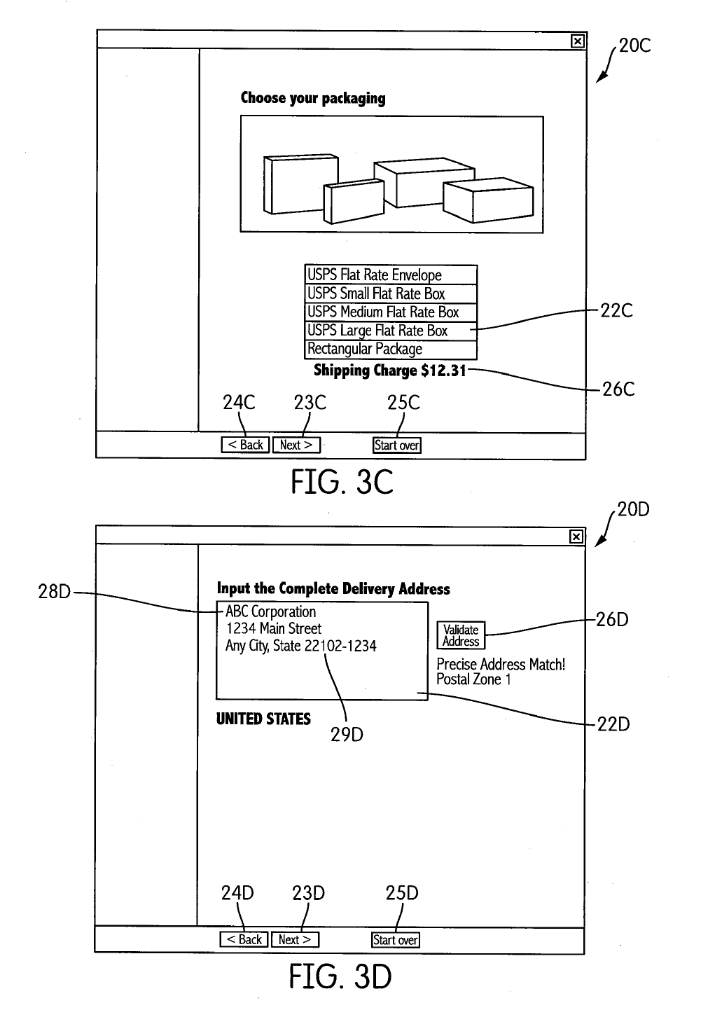

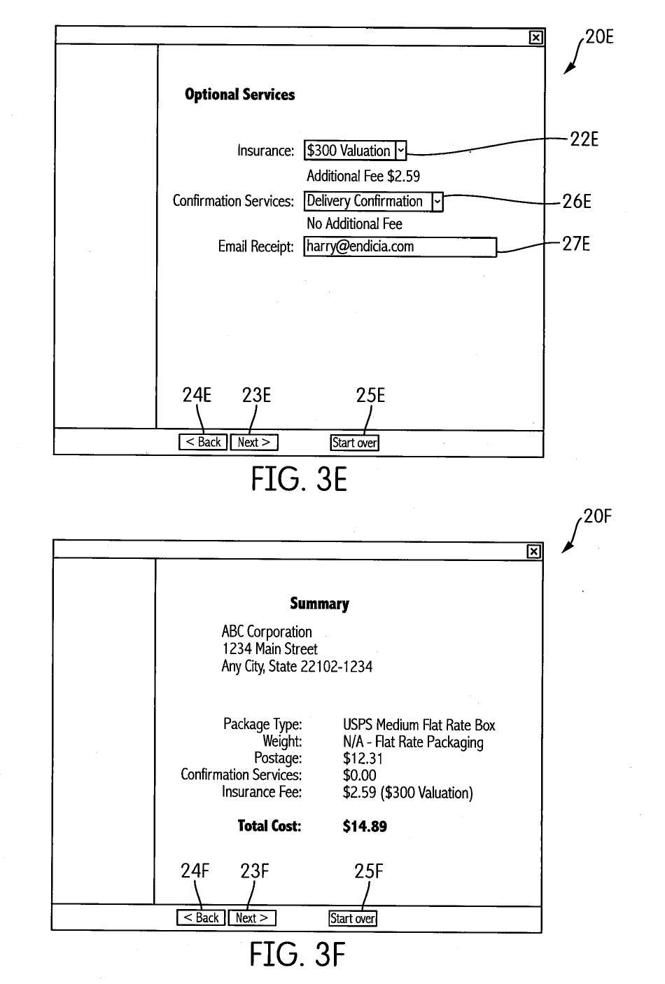

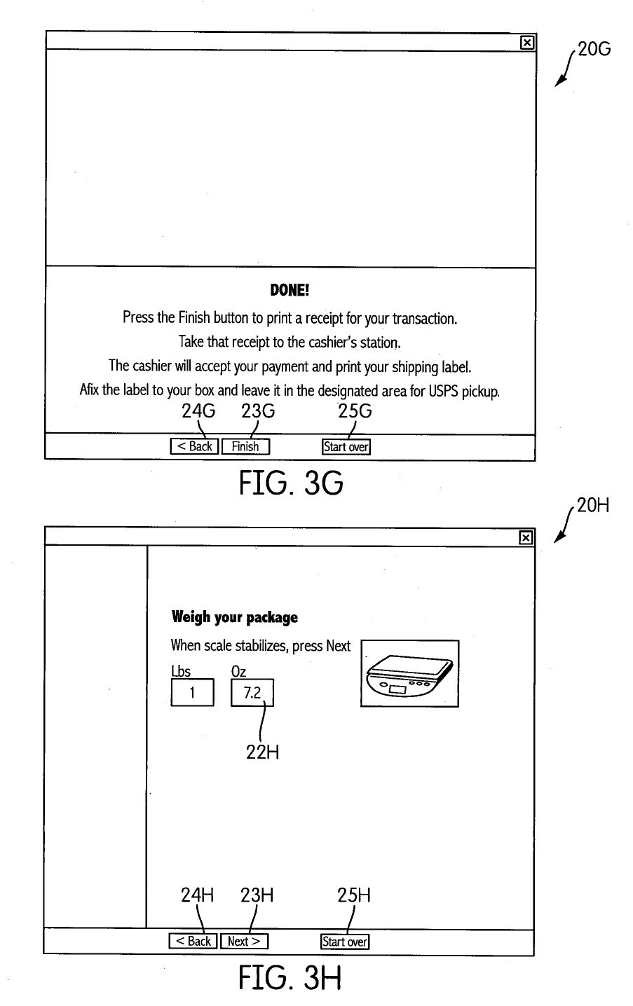

FIGS. 3A-3I show various graphical user interfaces of the first application for inputting shipping data, according to an embodiment of the present invention. FIG. 3A shows an initial graphical user interface or window 20A that is displayed on display device 122, according to an embodiment of the present invention. The window 20A provides a user various language options. For example, as depicted in FIG. 3A, the user can select a desired language (English, French, Spanish or German) by clicking on a corresponding image 21A, 21B, 21C or 21D. The user may also select a country for a destination of the package by scrolling through a menu 22A. As shown in FIG. 3A, “United States of America” is selected as the destination country at 22A. The user can then proceed by clicking on the button “Next” 23A at the bottom of the window 20A.

Upon clicking on the button “Next” 23, a window 20B is displayed on display device 122. FIG. 3B shows the window 20B, according to an embodiment of the present invention. The window 20B is a certification window provided to certify that the user is not shipping anything fragile, perishable, liquid, or potentially dangerous, for example, in compliance with USPS regulations. The user can provide the certification by checking the space 22B. Then, the user can click on button “Next” 23B to proceed to a next window 20C or button “Back” 24B to return to the previous window 20A or button “start over” 25B to return to initial window 20A. If the user clicks on the button “Next” 23B, window 20C is displayed on the display device 122.

FIG. 3C shows the window 20C, according to an embodiment of the present invention. At window 20C, the user is provided with a menu 22C for selecting the type of packaging or mailing including, for example, USPS Flat Rate Envelope, USPS Small Flat Rate Box, USPS Medium Flat Rate Box, and Rectangular Package. In one embodiment, once the user selects the type of package or mailing, a shipping charge is displayed at 26C. Then, the user can click on button “Next” 23C to proceed to a next window 20D or button “Back” 24C to return to the previous window 20B or button “start over” 25C to return to initial window 20A. If the user clicks on the button “Next” 23C, window 20D is displayed on the display device 122.

FIG. 3D shows the window 20D, according to an embodiment of the present invention. Window 20D includes a sub-window 22D for inputting the destination address 28D and zip code 29D. Once the user is satisfied with the address, the user can click on button “Validate Address” 26D so that the software application can check the validity of the inputted address 28D and zip code 29D by verifying the address 28D and zip code 29D against a master database (e.g., USPS master database). In one embodiment, once the user inputs the destination address 28D and destination zipcode 29D, the user can click on button “Next” 23C to proceed to a next window 20E or button “Back” 24D to return to the previous window 20C or button “start over” 25D to return to initial window 20A. If the user clicks on the button “Next” 23D, window 20E is displayed on the display device 122.

FIG. 3E shows the window 20E, according to an embodiment of the present invention. Window 20E includes various optional services that may be requested by the user. For example, the window 20E may include a sub-window 22E for inputting an approximate value of the item being shipped for insurance purposes. For example, as shown in FIG. 3E, a value of “$300” is input in the valuation window 22E. The window 20E may also include confirmation service window 26E, for example, for requesting “Delivery Confirmation. The window 20E may also include a space 27E for inputting an email address, for example, for inputting an email address of the user to receive the delivery confirmation. In one embodiment, once the user optionally specifies the various optional services as indicated above, the user can click on button “Next” 23E to proceed to a next window 20F or button “Back” 24E to return to the previous window 20D or button “start over” 25E to return to initial window 20A. If the user clicks on the button “Next” 23E, window 20F is displayed on the display device 122.

FIG. 3F shows the window 20F according to an embodiment of the present invention. The window 20F is a confirmation window displaying the data previously entered by the user in the various windows 20B-20E. For example, as shown in FIG. 3F, window 20F includes the destination address, the destination zipcode, the package type, the postage amount, the confirmation service fee, the insurance fee for the value of the item to be shipped as well as the total cost for shipping. This window 20F allows the user to check or review at a glance the various entries made by the user as well as the various amounts, costs or fees for shipping the package containing the item or items. In one embodiment, once the user reviews the various entries and costs, the user can click on button “Next” 23F to proceed to a next window 20G or button “Back” 24F to return to the previous window 20E or button “Start Over” 25F to return to initial window 20A. If the user clicks on the button “Next” 23F, window 20G is displayed on the display device 122.

FIG. 3G depicts the window 20G according to an embodiment of the present invention. The window 20G is a final window indicating to the user that the process of inputting data is finished and directs the user to retrieve a receipt of the transaction such as a printed base material (e.g., a printed paper slip) output by printing device 123 and to present the receipt or paper slip to a cashier or clerk for further processing as will be described in detail in the following paragraphs. In one embodiment, the user can click on button “Finish” 23G to proceed to print the receipt or button “Back” 24G to return to the previous window 20F or button “start over” 25G to return to initial window 20A.

The method may further include weighing the item to be mailed on the weighing scale 124, at S12. In one embodiment, the weight is automatically captured or read by the processor 124 and entered into the graphical user interface 20H, at 26A. FIG. 3H depicts a window or graphical interface 20H displaying the weight of the package to be shipped, according to an embodiment of the invention. In another embodiment, the weight is displayed by the weighing scale 124 and the displayed weight is entered manually by the user using the input device 121 into the graphical interface or window 20H, at window 22H. In yet another embodiment, the item may not be weighted if the weight of the item is known or not needed. The window 20H can be displayed when the first software application detects that the user entered shipping input parameters that require weighing the package to be shipped for proper computation of the shipping cost. This may be the case, for example, where the package is not a flat rate box. In one embodiment, once the user captures the weight 22H, the user can click on button “Next” 23H to proceed to a next window or button “Back” 24H to return to a previous window or button “start over” 25H to return to initial window 20A.

In addition, in the case where the package is to be shipped to a foreign country, the first software application can also display on the display device 122 a window 201 for allowing the user to input a description of the contents or items of the package to be shipped for customs handling purposes. FIG. 31 depicts the window 201 according to an embodiment of the present invention. The windows 201 includes various spaces 221 for inputting a description of the item or items in the package, the approximate weight of the item or items and the approximate value of the item or items within the package. The window 201 can be displayed when the first software application detects that the user entered shipping input parameters that specify that the package is to be shipped outside the country (e.g., outside USA). In one embodiment, once the user inputs the description and value of the item or items to be shipped, the user can click on button “Next” 231 to proceed to a next window or button “Back” 241 to return to a previous window or button “start over” 251 to return to initial window 20A.

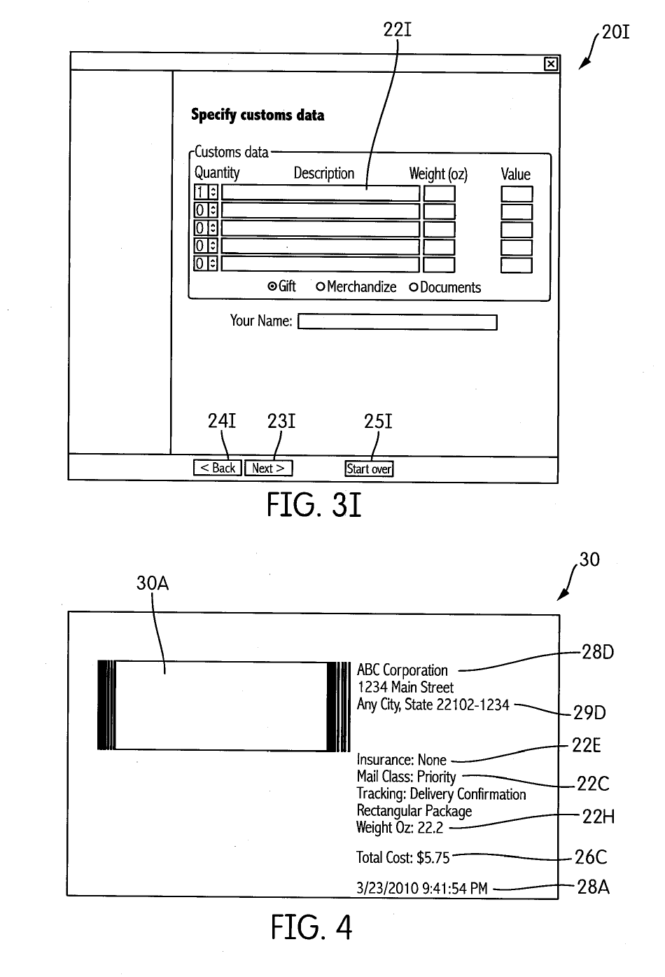

The method further includes computing a cost of shipping based upon the input data and optionally the weight of the item or package, at S14, and displaying the cost of shipping on the display device 122, at S 16. In one embodiment, the shipping cost is displayed at window 26C within graphical user interface or window 20C, as shown in FIG. 3C. The method further includes printing an information-bearing mark onto a base material (e.g., a paper slip) 30 using printing device 123, at S18. The base material can be of any type, for example, paper, plastic, or other substrate. FIG. 4 depicts an example of a base material (e.g., a paper slip) 30 output by printing device 123, according to an embodiment of the present invention. The paper slip 30 includes the destination address 28D , the destination zip code 29D, the type of mail service 22C such as “Priority,” the weight 2211, insurance valuation 22E and the date and time 28A of printing the paper slip 30, the cost of shipping 26C and any other data as desired. The paper slip 30 further includes an information-bearing mark in a form of a barcode 30A or any other type of readable or scannable image. In one embodiment, the printed barcode 30A is a two dimensional barcode.

After the customer or user retrieves the paper slip 30. The customer can take the paper slip 30 and present the paper slip 30 to a clerk having access to the second computer system 14 (e.g., at a counter of a hotel or retail store) for capturing or reading the data on the paper slip 30 and printing a shipping label.

The method further includes capturing or reading the data on the printed paper slip 30 using the input device 141 of the second computer system 14, at S20. In one embodiment, reading the data on the printed slip 121A includes scanning the two dimensional barcode 30A using the input device 141 (e.g., a barcode reader). In one embodiment, the reading can be performed by a sales person or clerk where the user or customer does not have direct access to the second computer system 14. The data on the printed slip 121A is captured by a second software application executed by the second computer system 14. The captured or read data is displayed in a graphical user interface 40 of the second software application on display device 142 of the second computer system 14.

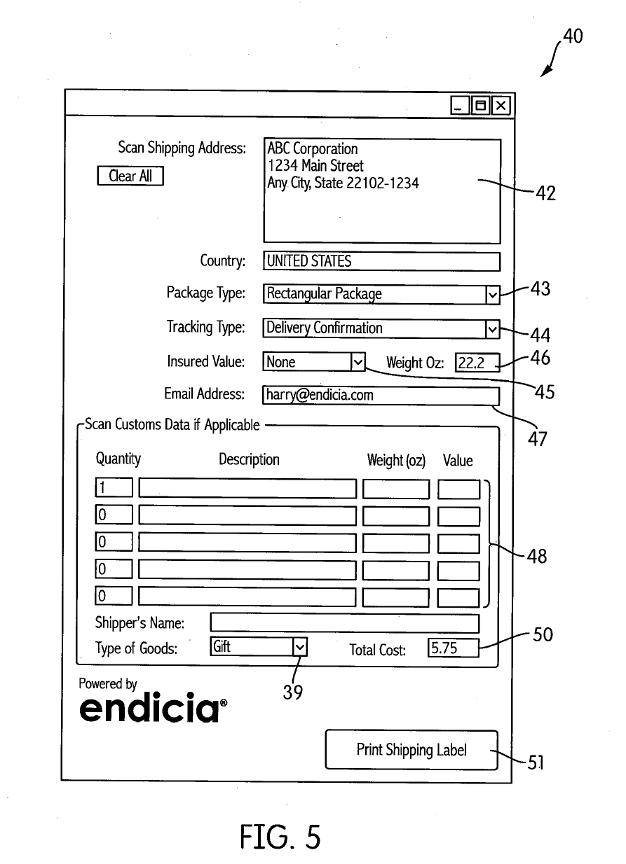

FIG. 5 depicts the graphical user interface 40, according to an embodiment of the present invention. The graphical user interface 40 includes various windows where the captured data is displayed. The captured data includes the destination address displayed at 42, the type of package displayed at 43, the type of tracking requested by the customer displayed at 44, the insured value displayed at 45, the weight of the package displayed at 46 and any other pertinent data, as desired. For example, by displaying the captured data on the graphical interface 40, the user, clerk or sales associate can have the opportunity to correct any erroneous data or complete any data that is missing or incomplete. In addition to captured data relating to the item to be mailed, the user, clerk or sales associate can input additional data such as an email address of the customer, displayed at 47 in the graphical user interface 40 for receiving a delivery confirmation or a digital receipt for the item mailed, or the like. Furthermore, the user, clerk or sales associate can further populate one or more windows 48 relating to the contents of the package for customs identification and custom fees assessment. In addition, a type of goods or items in the package to be shipped can be identified at window 39. The total cost for shipping (e.g., $5.75) can be reported at window 50.

After paying for the amount or cost for shipping (e.g., $5.75), the user, clerk or sales associate can click on the button “Print Shipping Label” 51 to print a shipping label 60 using the printing device. 143 of the computer system 14, at S22. After printing the shipping label 60, the shipping label 60 can be affixed or otherwise attached to the item, package or mail to be shipped and then the item, package or mail inducted into the mail stream for delivery (e.g., inducted into the USPS mail stream for delivery).

For example, one benefit of using a system or method according to an embodiment of the present invention with two distinct operations: an information gathering phase (e.g., where a user or customer inputs the mailing information such as the address and zipcode, etc.) and a postage label printing phase (e.g., performed by a mail clerk) is that such system can reduce the chances of fraud (e.g. stealing of postage).

For example, the mailing information and key decisions are made on the first computer system by a first party (the customer) desiring to use the shipping service for mailing an item to produce or output an information-bearing mark based on data input by the customer or user. The second computer reads (e.g., scans) in the resulting information-bearing mark and is able to produce a postage-bearing label or mail piece based on the read (e.g., scanned) information-bearing mark. This allows the actual “money handling” to be performed by a second party different from the user or customer (the party can be for example a mail clerk or hotel attendant, etc.). The second party (e.g., the mail clerk) can process a payment by credit card, cash, etc. Hence, in one embodiment, the first party (the customer) is not permitted to actually print postage using the second computer system.

For example, the present two-phase approach can also be implemented in a corporate or campus like environments. In such environments, the mailing room may want to control all shipping and postage expenditures. However, the mailing room does not want to be burdened with typing in address or customs information for a shipment. The mailing room simply wants to control expenditures by processing the payment for the postage and pass the package on to the courier (e.g., USPS). The two-phase approach is well suited for such environments. For example, an employee of a corporation can prepare a package, input the complete delivery address in a first computer system such as a client computer (through a web or stand alone interface), and print on a base material (e.g., paper) an information-bearing mark (e.g., a barcode) and optionally human readable data (e.g., a destination address, zipcode, etc.). For example, the employee can attach the base material having the information-bearing mark on the package and have the package picked up by mail room staff. When the package arrives at the mailroom, the mail room staff or mail room clerk processes the package. The information bearing mark can be read by a second computer system and all of the relevant data (service type, insurance, customs data) is transferred to a postage printing software. In this way, the mailroom (the second party) retains control over disbursements and payment for postage and yet the end customer (e.g., the first party on the 4^{th} floor of the corporation) can fully specify where and how the package is to be shipped. In one embodiment, the information-bearing mark (e.g., barcode) may further include a cost code such that when the information bearing mark is read (e.g., scanned) by the second computer, the cost of shipping is reported to a postage log of the entity implementing the present mailing system and method for cost accounting.

This two-phase approach can also be used in a scenario where the first computer system 12 is a personal computer, located at a user's home, for example, and the second computer system 14 is located at a remote location from the user's home, such as a hotel, a retail store, etc. The user can take the printed paper slip 30 and present the paper slip 30 to a clerk, cashier or postal agent having access to the second computer system 14 for capturing or reading the data on the paper slip 30 and printing a shipping label. Therefore, as it can be appreciated, the first computer system 12 and the second computer system 14 may or may not be co-located in a same area, room or building.

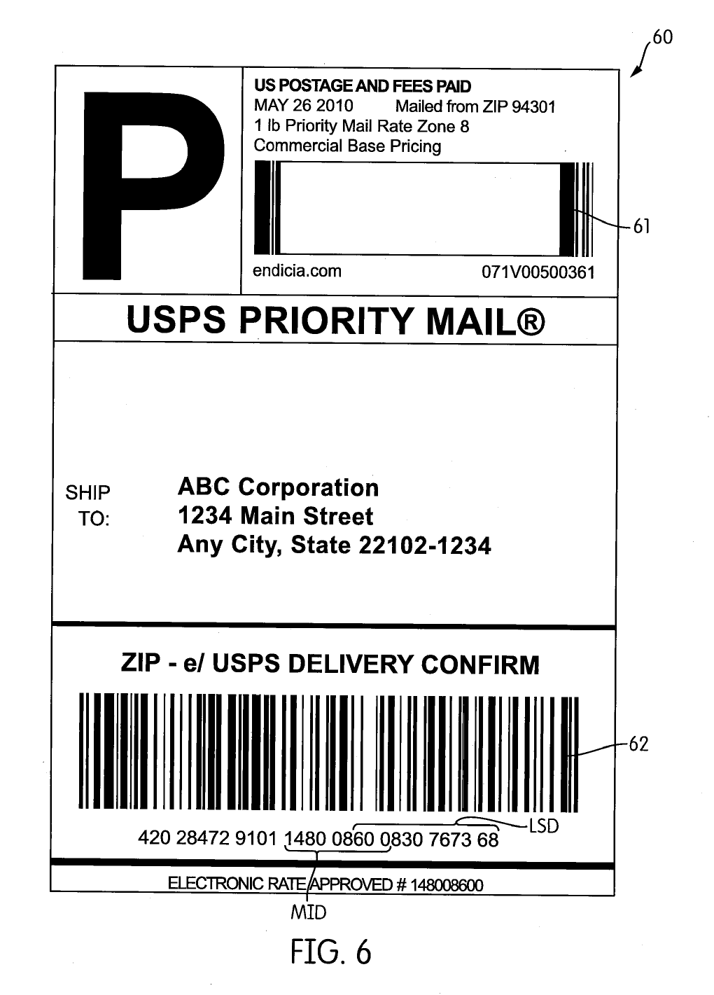

FIG. 6 is an example of a shipping label 60, according to an embodiment of the present invention. For example, the shipping label can be a USPS PRIORITY MAIL® shipping label. The shipping label 60 includes the destination address 28D and destination zipcode 29D. The shipping label 60 further includes a 2D barcode indicium 61 providing a proof of payment and a 1D barcode indicium 62 provided for tracking and/or delivery confirmation. In one embodiment, the 2D barcode indicium 61 is postage IBI (information based indicia) barcode, representing a given mail class (first class mail, priority mail, express mail, etc.). In one embodiment, the 2D barcode may include a serialized indicium or piece count. The 2D barcode provides an indication that shipping cost was paid for by the mailer or user (e.g., postage and fees are paid to USPS). In one embodiment, the 2D barcode may further include a type of encryption algorithm used to encrypt the barcode (e.g., RSA, DSA, etc.), a certificate ID of the DSA or RSA key used for signing the data encoded in the barcode, a shipper's USPS meter account, total funds issued by the meter account, the amount of postage on the mail piece, remaining funds in the meter account, the origin zipcode of the shipper, a destination zipcode, a date of printing, a software identification number of the software that produced the barcode, a piece-count, the mail class rate, a Least Significant Digit(s) (LSD) of the tracking number, or a digital signature, or any combination thereof.

The 1D barcode 62 is a tracking barcode which can be a “delivery confirmation” barcode in USPS First Class and/or Priority Mail or “an express mail tracking code” in USPS Express Mail. In one embodiment, the 1D tracking barcode includes a postal service issued mail identification number (MID). In one embodiment, the MID number is placed around a middle portion of the 1D tracking barcode 62. For example, as shown in FIG. 6, the MID is “148008600.” The MID is assigned or issued by the USPS to the shipper (i.e., the entity processing the shipment). In one embodiment, the 1D tracking barcode includes a Least Significant Digit(s) (LSD). For example, as shown in FIG. 6, the LSD is “600830767368.” In one embodiment, the entity processing the shipment can be the entity that provides the method or system for generating the mailing label.

In some embodiments, application programs for performing methods in accordance with embodiments of the invention can be embodied as program products in a computer(s) such as a personal computer or server or in a distributed computing environment comprising a plurality of computers. The computer(s) may include, for example, a desktop computer, a laptop computer, a handheld computing device such as a PDA, etc. The computer program products may include a computer readable medium or storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card (e.g., a USB flash card), PCMCIA memory card, smart card, or other media. Alternatively, a portion or the whole computer program product can be downloaded from a remote computer or server via a network such as the internet, an ATM network, a wide area network (WAN) or a local area network.

Stored on one or more of the computer readable media, the program may include software for controlling both the hardware of a general purpose or specialized computer or processor. The software also enables the computer or processor to interact with a user via output devices such as a graphical user interface, head mounted display (HMD), etc. The software may also include, but is not limited to, device drivers, operating systems and user applications.

Alternatively, instead or in addition to implementing the methods described above as computer program product(s) (e.g., as software application products) embodied in a computer, the method described above can be implemented as hardware in which for example an application specific integrated circuit (ASIC) can be designed to implement the method or methods of the present invention.

Although the various steps of the method(s) are described in the above paragraphs as occurring in a certain order, the present application is not bound by the order in which the various steps occur. In fact, in alternative embodiments, the various steps can be executed in an order different from the order described above.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed:

1. A method for generating a mailing label, comprising:
inputting data relating to an item to be mailed into a first computer system;
printing, by the first computer system, an information-bearing mark onto a base material, the information-bearing mark associated with the data relating to the item;
reading, by a second computer system, the information-bearing mark on the base material; and
printing, by the second computer system, the mailing label for mailing the item based on the read information-bearing mark.

2. The method according to claim 1, further comprising computing, by the first computer system, a cost of mailing based on the input data.

3. The method according to claim 1, wherein inputting of data relating to the item to be mailed comprises inputting a destination address and a destination zip code.

4. The method according to claim 3, wherein inputting data further comprises inputting dimensions of the item, inputting the type of mail service, or a tracking service, or any combination of two or more thereof.

5. The method according to claim 1, further comprising weighing the item.

6. The method according to claim 5, further comprising computing a cost of mailing based on a weight of the item.

7. The method according to claim 1, wherein printing onto the base material comprises printing onto a paper slip.

8. The method according to claim 1, further comprising printing, on the base material, a destination address, a destination zip code, a type of mail service, a cost of mailing, or any combination of two or more thereof.

9. The method according to claim 1, wherein the information-bearing mark comprises a barcode.

10. The method according to claim 1, wherein reading the information-bearing mark comprises scanning the information-bearing mark using a scanner.

11. The method according to claim 1, wherein the mailing label includes an indicium providing a proof of payment for the mailing label.

12. The method according to claim 1, wherein the mailing label includes a tracking indicium for tracking the mailing label.

13. A system for generating a mailing label, the system comprising:
a first computer system configured to print an information-bearing mark on a base material, the information-bearing mark associated with data relating to the item; and
a second computer system configured to read the information-bearing mark on the base material, and print the mailing label for mailing the item based on the read information-bearing mark.

14. The system according to claim 13, wherein the first computer is further configured to compute a cost of mailing based on the data relating to the item.

15. The system according to claim 13, wherein the first computer system comprises a processor, an input device in communication with the processor, the input device configured to input data including a destination address and a destination postal code, or dimensions of the package, or a combination of two or more thereof.

16. The system according to claim 15, wherein the first computer system further comprises a display device in communication with the processor, the display device configured to display the data relating to the item and a cost of mailing the item.

17. The system according to claim 15, wherein the first computer system further comprises a printing device configured to print the information-bearing mark on the base material.

18. The system according to claim 13, wherein the second computer system comprises a processor, an input device in communication with the processor, the input device configured to read the information-bearing mark on the base material.

19. The system according to claim 18, wherein the second computer system further comprises a display device in communication with the processor, the display device configured to display the cost of mailing.

20. The system according to claim 18, wherein the second computer system further comprises a printing device configured to print the mailing label.

21. The system according to claim 13, wherein the mailing label includes an indicium providing a proof of payment for the mailing label.

22. The method according to claim 13, wherein the mailing label includes a tracking indicium for tracking the mailing label.
